(19) United States
(12) Patent Application Publication
(10) Pub. No.: US 2014/0363797 A1
(43) Pub. Date: Dec. 11, 2014

(54) METHOD FOR PROVIDING WELLNESS-RELATED DIRECTIVES TO A USER

(71) Applicant: Lark Technologies, Inc., Mountain View, CA (US)

(72) Inventors: Julia Hu, Mountain View, CA (US); Jeff Zira, Mountain View, CA (US)

(73) Assignee: Lark Technologies, Inc., Mountain View, CA (US)

(21) Appl. No.: 14/289,384

(22) Filed: May 28, 2014

Related U.S. Application Data
(60) Provisional application No. 61/827,916, filed on May 28, 2013.

(51) Int. Cl. G09B 19/00

(52) U.S. Cl. CPC G09B 19/00
USPC 434/236

(57) ABSTRACT

One variation of a method for providing wellness-related directives to a user includes: at a computing device associated with the user, receiving a selection for a first wellness application and a selection for a second wellness application; receiving a first set of motion data collected by the computing device and a wearable device wirelessly coupled to the mobile computing device; generating a first directive for the user according to the first set of motion data and a first rule defined within the first wellness application; identifying a conflict between the first directive and a second directive, the second directive generated from motion data received from the wearable device according to a second rule defined within the second wellness application; and electing the first directive for presentation to the user in place of the second directive according to a conflict resolution scheme.

### CROSS-REFERENCE TO RELATED APPLICATIONS

This application claims the benefit of U.S. Provisional Application No. 61/827,916, filed on 28 May 2013, which is incorporated in its entity by this reference.

The Application is related to U.S. patent application Ser. No. 14/048,956, filed on 8 Oct. 2013, which is incorporated in its entity by this reference.

### TECHNICAL FIELD

This invention relates generally to the field of digital health, and more specifically to a new and useful method for providing wellness-related directives to a user in the field of digital health.

### BRIEF DESCRIPTION OF THE FIGURES

FIG. 1 is a flowchart representation of a method of the invention;

FIG. 2 is a flowchart representation of one variation of the method;

FIG. 3 is a flowchart representation of one variation of the method;

FIG. 4 is a schematic representation of one variation of the method;

FIG. 5 is a flowchart representation of one variation of the method;

FIG. 6 is a graphical representation in accordance with one variation of the method;

FIG. 7 is a graphical representation in accordance with one variation of the method;

FIG. 8 is a graphical representation in accordance with one variation of the method;

FIG. 9 is a graphical representation in accordance with one variation of the method;

FIG. 10 is a flowchart representation in accordance with one variation of the method; and

FIG. 11 is a flowchart representation in accordance with one variation of the method.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### 1. Method and Variations

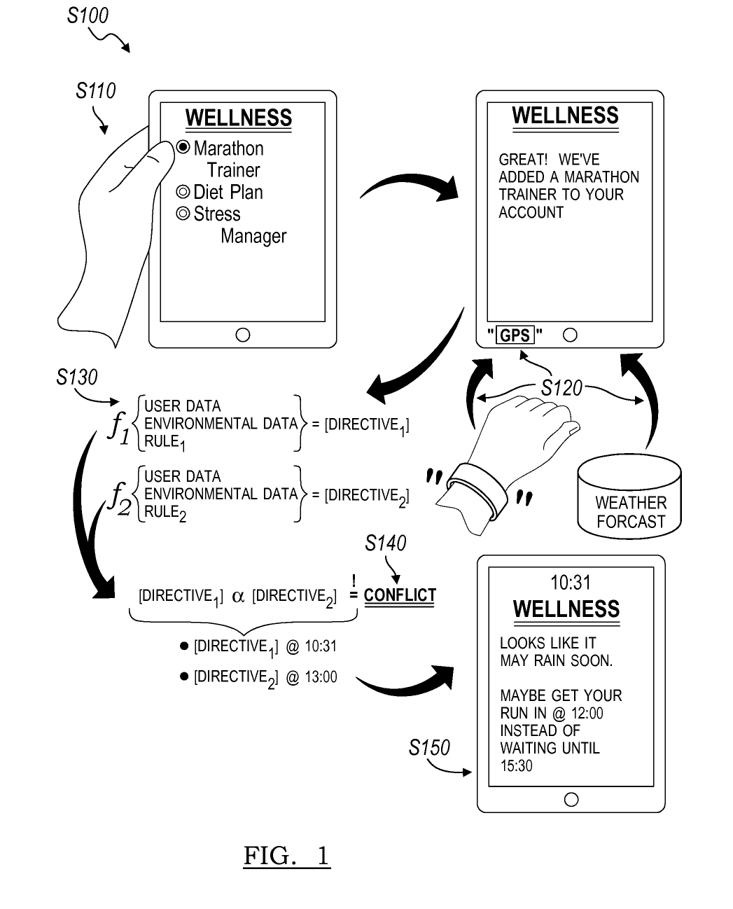

As shown in FIG. 1, a method S100 for providing wellness-related directives to a user includes: at a computing device associated with the user, receiving a selection for a first wellness application and a selection for a second wellness application in Block S110; receiving a first set of motion data collected by the computing device and a wearable device wirelessly coupled to the mobile computing device in Block S120; generating a first directive for the user according to the first set of motion data and a first rule defined within the first wellness application in Block S130; identifying a conflict between the first directive and a second directive, the second directive generated from motion data received from the wearable device according to a second rule defined within the second wellness application; and electing the first directive for presentation to the user in place of the second directive according to a conflict resolution scheme in Block S140.

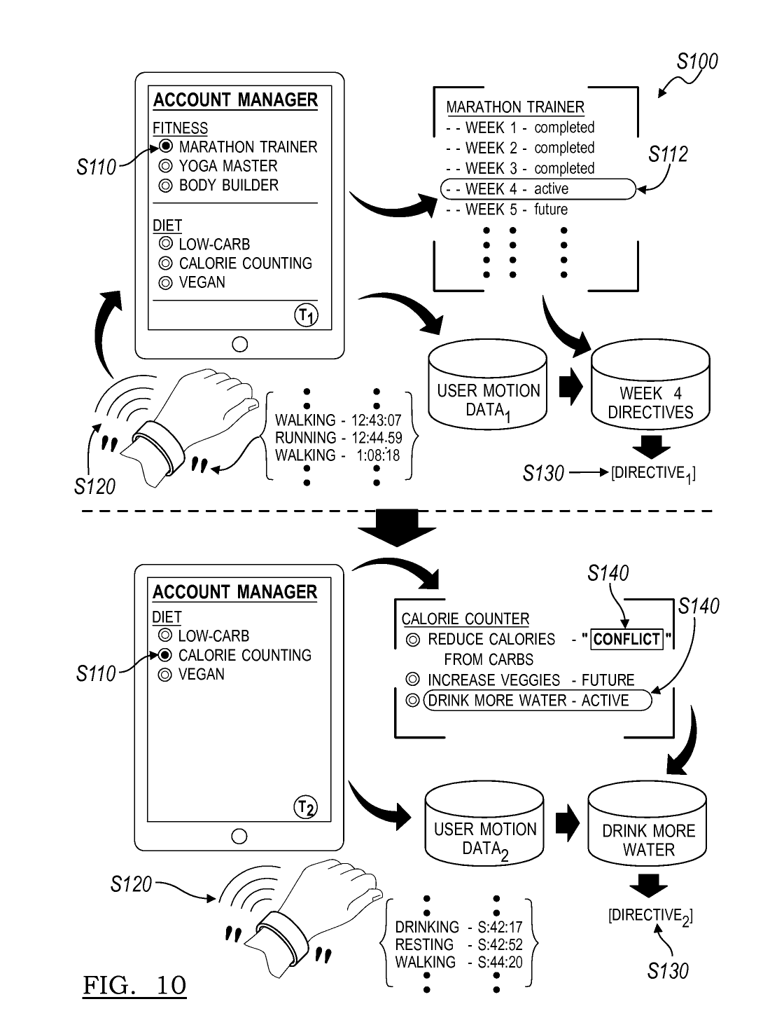

As shown in FIG. 10, one variation of the method S100 includes: at a computing device associated with the user, receiving a selection for a first wellness application and a selection for a second wellness application in Block S110; selecting a first habit program within the first wellness application in Block S112; receiving a first set of motion data collected by the computing device and a wearable device wirelessly coupled to the mobile computing device in Block S120; selecting a first directive from the first habit program for presentation to the user according to the first set of motion data in Block S130; identifying a conflict between the first habit program and a second habit program within the second wellness application based on a conflict resolution scheme in Block S140; selecting a third habit program within the second wellness application in place of the second habit program in Block S112; receiving a second set of motion data collected by the wearable device wirelessly in Block S120; and selecting a second directive from the third habit program for presentation to the user according to the second set of motion data in Block S130.

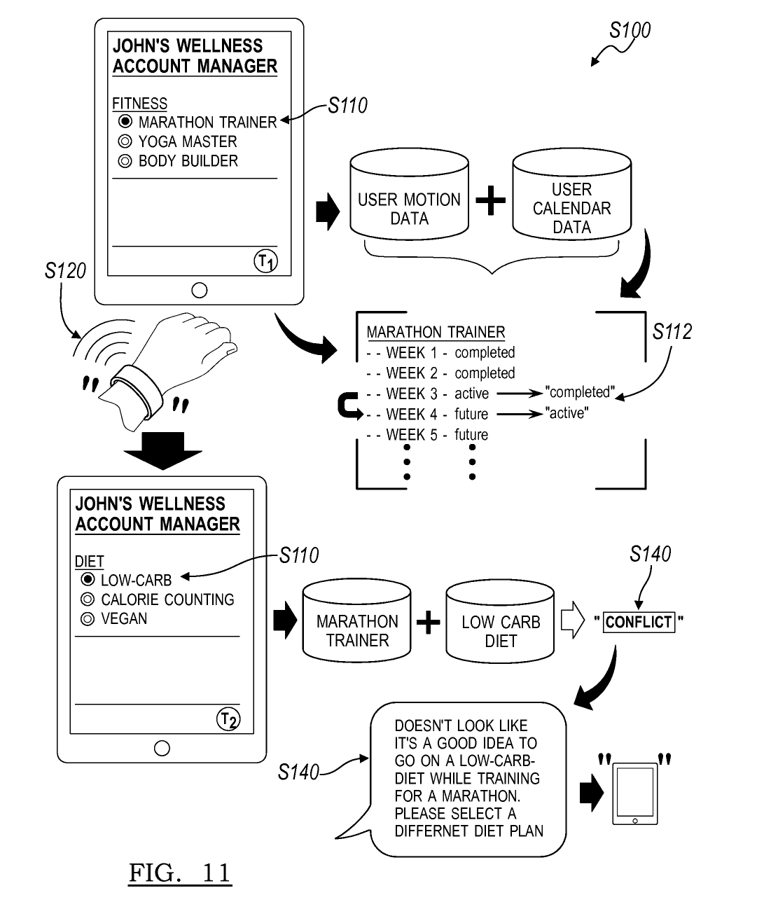

As shown in FIG. 11, another variation of the method S100 includes: receiving, from a user, an election of a first wellness application to a wellness account associated with the user in Block S110; receiving a set of motion data collected by a computing device and a wearable device in Block S120, the computing device linked to the wellness account, the wearable device in wirelessly communication with the mobile computing device; identifying completion of a first habit program by the user based on the set of motion data, the first habit program defined within the first wellness application; selecting a second habit program within the first wellness application in response to completion of the first habit program by the user in Block S112; receiving, from the user, an election of a second wellness application to the wellness account in Block S111; identifying a conflict between the first wellness application and the second wellness application; and rejecting the second wellness application from the wellness account based on the conflict in Block S140.

### 2. Applications

As shown in FIG. 3, the method S100 can be implemented within a wellness platform supporting wellness applications hosted by various wellness partners. Generally, the method S100 can enable each of various independent health-, fitness-, and wellness-related entities (i.e., partners), such as a health insurance company, a diet program, a weight-loss system, a stress manager, a sleep program, a sports team, a college campus, a food vendor or grocer, a training program, a gym, etc., to supply an independent wellness application that provides guidance to the a user to develop positive behaviors (e.g., habits) within a corresponding wellness (or health) category. The wellness platform (e.g., through the method S100) can automatically elect one or more wellness applications on behalf of a user or receive manual selections for wellness applications from the user, add the elected or selected wellness application(s) to a wellness account for the user, distribute user data collected over time, such as through a mobile computing device and/or a wearable device, into the wellness applications to generate behavior-related directives, and then present these directives to the user, such as through the mobile computing device. As described in U.S. patent application Ser. No. 14/048,956, filed on 8 Oct. 2013 and incorporated in its entirety by this reference, a user account supported within the wellness platform and implementing the method S100 can receive and/or record user and environmental data from one or more devices or remote databases, manage a set of rules defined by each wellness application selected by the user, and apply the rules to the user and/or environmental data to output wellness-related directives t the user, such as in the form or a reminder or feedback for a user action or behavior. For example, the method S100 —through the user account and the wellness platform—can apply a set of rules in the form of an algorithm, a parametric model, or a non-parametric model—as specified by a particular wellness application—to various user data to select and/or generate a timely directive to prompt the user to perform a particular action to build a positive behavior and/or to recognize a positive action recently performed by the user in establishing a positive habit.

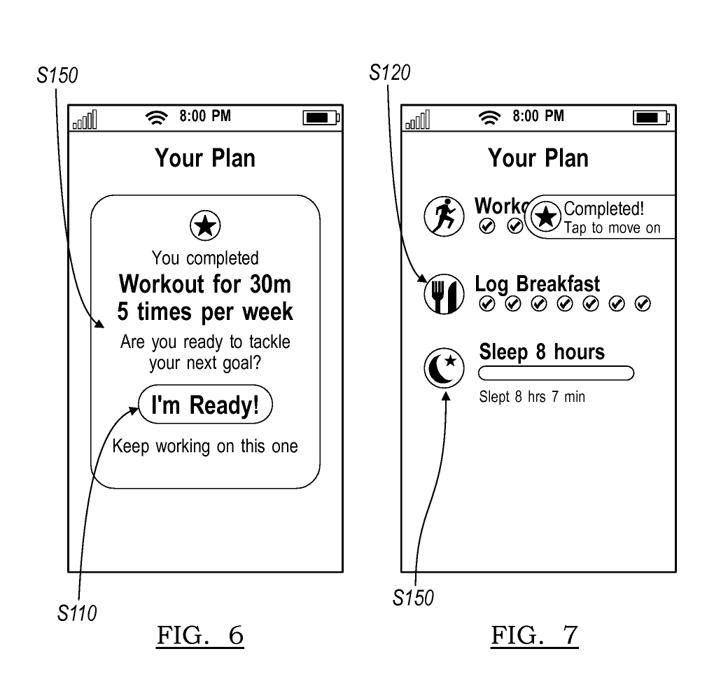

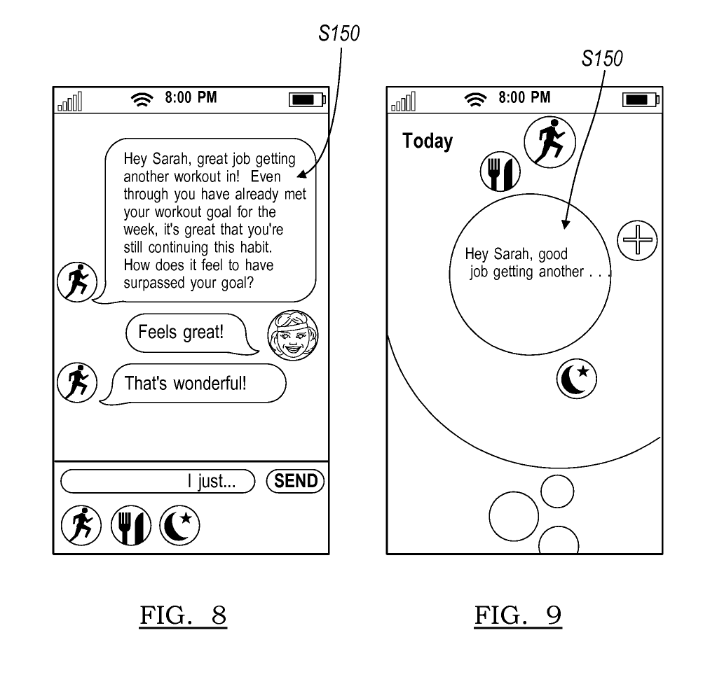

As shown in FIGS. 6 and 8, the wellness platform can support wellness applications that output directives related to one or more wellness categories, such as fitness, exercise, stress, sleep, and/or diet, based on user and/or local environment data. For example, the wellness platform can support an independent diet program that defines rules for aiding a user in consuming particular foods at certain times, an independent ‘marathon’ program that defines rules for aiding the user in training for a marathon, an independent stress manager that defines rules for aiding the user in reducing stress, an independent gym program that defines rules for aiding the user in losing weight, and an independent sleep program that defines rules for aiding the user in getting enough sleep and managing sleep cycles. Furthermore, the wellness platform can support multiple wellness applications in one or more areas of health and wellness. For example, the wellness platform can support multiple diet-related wellness applications, such as one or more ‘low-carb’ diet programs, juice-only diet programs, vegan diet programs, gluten-free diet programs, etc.

The wellness platform can thus enable a user to select diet program, sleep program, or stress-management program, or any other suitable type of wellness application that is of particular interest or that is particularly applicable to the user. In particular, each wellness application supported within the wellness platform can define one or more habit programs, each habit program specifying a particular behavior for development by a user, as described below. For example, each wellness application elected to a user's wellness account can define rules for manipulating user and/or environmental data to output—to the user—coaching-type directives corresponding particular wellness areas. A wellness application can be associated with a particular wellness goal, such as weight loss, stress management, an exercise achievement (e.g., completing a marathon), etc., and the wellness application can thus provide custom coaching services and coaching content to guide the user in developing particular behaviors that support the particular wellness goal.

As shown in FIG. 3, the wellness platform can further enable the user to create, maintain, modify, and build a wellness account (e.g., a user profile), such as a private wellness account accessible through a native application executing on a smartphone, as described below. The wellness platform can also enable the user to add multiple wellness applications to the wellness account. For example, the wellness platform can enable the user to select one wellness application from multiple wellness categories, such as one sleep program and one diet program. The wellness platform can also enable the user to select multiple wellness applications in one wellness category, such as a yoga application and a weightlifting application.

However, execution of multiple wellness applications within one user's wellness account simultaneously (e.g., during a period of time, such as two weeks) may result in selection (or generation) of conflicting directives from two distinct wellness applications, such as at substantially identical times in response to new user data and/or new environmental data or within a threshold time period. The wellness platform can therefore implement the method S100 to detect such conflicts or collisions between directives from two or more distinct wellness applications selected for or elected by the user. Similarly, execution of multiple wellness applications within the user's wellness account may result in selection of conflicting habit programs (i.e., conflicting targeted behaviors) from two distinct wellness applications during a period of time. For example, a second habit program—within a second wellness application—targeting a second behavior may be at odds with a first behavior targeted by a first habit program—within a first wellness application—that was previously selected and currently executing in the user's wellness account. The wellness platform can therefore implement the first variation of the method S100 to detect such conflicts or collisions between habit programs within two or more distinct wellness applications selected for or elected by the user. Furthermore, by enabling selection of multiple wellness applications within the user's wellness account, a user may select conflicting wellness applications (i.e., wellness applications defining conflicting goals) for simultaneous execution on the wellness platform or for asynchronous execution but without sufficient time between execution of the conflicting wellness applications. The wellness platform can therefore implement the second variation of the method S100 to detect such conflicts or collisions between wellness application executing substantially simultaneously or within a limited period of time on the user's wellness account. Therefore, the wellness platform can implement the method S100 and/or the variation(s) of the method S100 to resolve conflicts between directives associated with different wellness applications, habit programs associated with different wellness applications, and/or wellness applications elected to a user's wellness account.

The wellness platform, the user's wellness account, and/or one or more Blocks of the method S100 can be implemented within a native application executing on a (mobile) computing device carried by the user, such as on a smartphone, a tablet, a smart watch, a pair of smart glasses, etc., to collect user data and to deliver timely directives to the user based on these user data. Alternatively, wellness platform, the user's wellness account, and/or the method S100 can be implemented on a computer network and accessed by the user through a user interface or a user dashboard, such as via a web browser executing on a (mobile or static) computing device in communication with a wearable device carried by the corresponding user. The method S100 can additionally or alternatively be implemented on one or more computer systems, such as a cloud-based computer system, a mainframe computer system, a grid-computer system, or any other suitable remote computer system. For example, the method S100 can be implemented by a remote cloud-based computer system (e.g., remote server) in communication with a smartphone carried by the user, wherein the computer system implements the method S100 to select or generate a directive and transmits the directive to the smartphone where the directive is displayed for the user, such as in the form or a notification on a locked or home screen or in the form of a message within a native wellness application. However, the wellness platform, the user's wellness account, and/or one or more Blocks of the method S100 can be implemented by or in cooperation with any other one or more mobile computing devices, wearable devices, processors, computers, computer networks, etc.

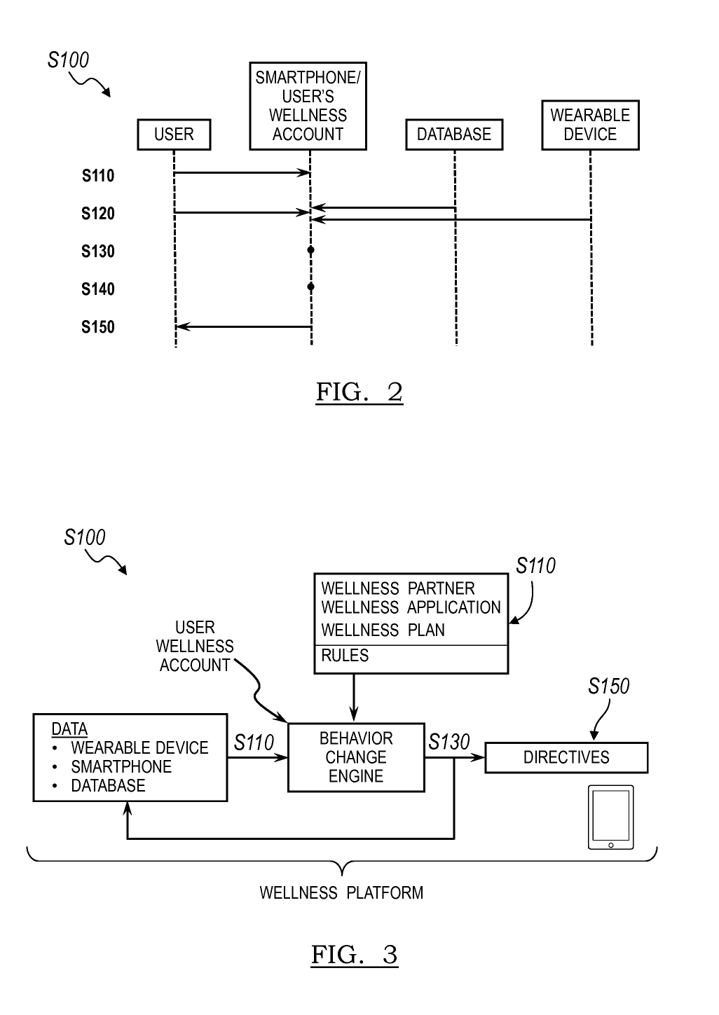

As shown in FIG. 2, the wellness platform, the user's wellness account, and/or the method S100 can further interface with various hardware and/or software systems, as described below. For example, the method S100 can interface with a smart wristband (or other wearable device) incorporating an accelerometer, a gyroscope, a temperature sensor, and/or a display, such as the smart wristband described in U.S. Provisional Application No. 61/710,867, filed on 8 Oct. 2012, which is incorporated in its entirety by this reference. The method S100 can thus collect user motion, temperature, and/or other user-related data from the smart wristband over time while the user wears the smart wristband. The method S100 can similarly interface with other external devices, such as a bath scale or a digital environment thermometer, to retrieve additional user or local environmental data. The method S100 can also interface with (or be implemented on or through) a mobile computing device (e.g., a smartphone) incorporating a GPS sensor, communication channels (e.g., email, SMS text messaging), and a display, etc. to receive relevant user data and to output directives to the user. The method S100 can further interface with an email server to track user communications, with a computer or other multimedia device to track user media consumption, with a cloud-based calendar to track the user's schedule, with a weather database to track local weather or environmental conditions, with a social network to identify user relationships and/or track another form of user communications, with a hospital database to retrieve and/or update user health records, etc. The method S100 can therefore receive and/or aggregate various user and environment data from multiple sources and implement this data, respective of one or more selected wellness applications, to output or generate a directive for the user.

### 3. Wellness Application and Habit Pro ram Selection

Block S110 of the method S100 recites receiving a selection for a first wellness application. Block S110 can similarly recite receiving, from a user, an election of a first wellness application to a wellness account associated with the user. Generally, Block S110 functions to receive a selection for a particular (i.e., the “first”) wellness application from a set of available wellness applications supported by the platform accessed by the user through his personal wellness account, as shown in FIG. 1. Once a wellness application selection is made by the user, Block S110 can add the wellness application to the user's wellness account, and the wellness account and subsequent Blocks of the method S100 can cooperate to deliver timely and pertinent directives associated with the selected wellness application to the user.

In one implementation, the wellness platform supports a wellness application storefront accessible by the user to select various wellness applications. In one example, a native application (linked to the user's wellness account and) executing on the user's mobile computing device can display the storefront, and Block S110 can receive a user selection for a particular wellness application from the storefront within the native application. In another example, a user dashboard accessible through a web browser executing on a multimedia device can display the storefront, and Block S110 can receive a user selection for a particular wellness application through the storefront within the web browser. However, Block S110 can capture one or more wellness application selections through any other suitable interface and/or from any other suitable list or storefront containing available wellness applications.

Block S110 can additionally or alternatively automatically elect a wellness application for the user, such as by selecting a default wellness application (e.g., a walking-related application) on behalf of the user.

As described above and shown in FIG. 5, each wellness application can define a set of rules defining manipulation of various user and/or environmental data to output a timely, relevant directive to the user. A wellness application can specify a wellness goal (e.g., “walking more”) and a corresponding wellness plan to achieve the goal (e.g., a diet or a workout plan), and the wellness plan can thus define a highest-level container of rules associated with a user's wellness goal. The wellness plan can include multiple habit programs (e.g., time blocks), wherein each habit program defines one or mode behaviors (e.g., habits) for the user to create, modify, or eliminate). The wellness plan can therefore include multiple habits such as major habits (e.g., a diet-related habit, an activity-related habit) and minor habits (e.g., a sleep-related habit, a mood-related habit). A wellness plan of a wellness application can therefore define a step-by-step program for achieving a wellness-related goal through creation of positive behaviors (and reduction of negative behaviors), and the user can progress through the wellness plan by achieving one behavior specified in one habit program and then moving on to developing behaviors in subsequent habit programs within the wellness application.

Blocks of the method S100 can apply then rules specified in a current habit program to generate a reminder to perform an action to develop and establish the corresponding behavior and/or to generate feedback for a recent user action or inaction pertaining to the behavior. For example, in a first weeklong habit program of a wellness plan within a wellness application selected by the user, Block S130 can output a reminder to “log all meals,” and, in a second weeklong habit program of the wellness plan, Block S130 can output a reminder to “log two vegetables per day.” The user can also be engaged in multiple habit programs within one wellness application simultaneously, such as one habit program that builds on another habit program. Block S110 can therefore receive a user selection of a wellness application that defines a set of rules, and subsequent Blocks of the method S100 can output timely reminders and user feedback according to the set of rules to support habit modification and positive reinforcement of good habits.

In one variation of the method S100, Block S110 recites, at a computing device associated with the user, receiving a selection for a first wellness application and a selection for a second wellness application. In this variation, Block S110 can receive a selection for each of multiple wellness applications, such as substantially back-to-back selections or asynchronous selections. In one implementation, Block S110 can receive a selection for a first wellness application at a first time and receive a selection for a second wellness application at a second time succeeding the first time. For example, Block S110 can receive an election for loading a diet-related application into a user's wellness account associated with the user and later (e.g., several days, weeks, months or years later) receive an election for loading a fitness-related application into the user's wellness account. In this example, the diet-related application can be supported by a first third-party provider, the fitness-related application can be supported by a second third-party provider other than the first third-party provider, and the first third-party provider and the second third-party provider can be external the wellness account and the wellness platform. Similarly, Block S110 can receive a user-election of a second wellness application in addition to a default first wellness application, such as several days, weeks, months, or years after initiating the default first wellness application when the user's wellness account is activated. However, Block S110 can function in any other way to receive a user selection of one or more wellness applications.

As shown in FIGS. 10 and 11, one variation of the method S100 can therefore include Block S112, which recites selecting a first habit program within the first wellness application. Generally, Block S112 functions to select a particular habit program within a current wellness application to execute within the user's wellness account such that a set of rules and directives defined within the particular habit program are applied to user and/or environmental data (collected in Block S120) to generate directives for the user (in Block S130) and to deliver the directives to the user in (Block S160).

In one implementation, Block S112 selects a default initial habit program once a wellness application is loaded into the user's wellness account and/or once the wellness application or wellness account is activated. In this implementation, as the user's completes habit programs or as habit programs expire (e.g., every two weeks), Block S112 can selected subsequent habit programs according to a default or static habit program schedule defined within the wellness application. Block

In another implementation, Block S112 selects a habit program from a set of available habit programs within a wellness application based on a preference of the user. For example, Block S112 can prompt the user to select habit programs (e.g., behaviors for development) from a list of available habit programs within the wellness application and set an order or rank of presentation of the habit programs to the user accordingly. In another example, Block S112 applies user data, such as a level of user success in completing a previous habit program, to select for the user a subsequent habit program from a set of available habits programs within a current wellness application. In this example, if a user failed a habit program of average difficulty, Block S112 can select a relatively easier subsequent habit program, such as to get the user back into a ‘habit’ of responding to directives issued through the wellness account. Block S112 can similarly select a particular habit program from a set of habit programs defined within a selected wellness application according to a selected goal entered by the user, a behavior targeted in a previous habit program, and/or a perceived difficulty of the previous habit program. Block can additionally or alternatively implement these data to rank or set a custom order for execution of habit programs within the wellness application within the user's wellness account.

In one implementation, Block S112 detects completion of a previously-selected habit program and selects a new (i.e., subsequent) habit program accordingly, as shown in FIG. 11. For example, Block S112 can analyze user and/or environmental data collected in Block S120 to identifying completion of a previous habit program by the user, such as indicated by habitual performance of a particular behavior by the user as extrapolated from user data over a preset period of time and at a confidence score above a threshold confidence score. In particular, in this example, Block S112 can identify a series of actions by the user over a period of time from a set of motion data pertaining to the user, correlate the series of actions by the user with establishment of a first behavior targeted in the previous habit program within the current wellness application, and terminate the previous habit program in response to establishment of a behavior targeted in the previous habit program. In this example, Block S112 can then select a subsequent second habit program that targets a second behavior building on the previous behavior once the previous habit program is terminated. Alternatively, Block S112 can monitor a time period specified for a first habit program and then terminate the first habit program and select a new habit program when the period for the first habit program expires.

However, Block S112 can select a habit program for each of one or more wellness applications installed in the user's wellness account in any other way and according to any other schema.

### 4. User Data

Block S120 of the method S100 recites receiving a first set of motion data collected by the computing device and a wearable device wirelessly coupled to the mobile computing device. Generally, Block S120 functions to interface with various sensors, devices, and/or databases to retrieve user information, such as asynchronously or in real-time as the data is collected or generated. For example, Block S120 of the method S100 can execute on the user's mobile computing device and download from a wearable device identified action changes performed by the user, wherein the wearable device includes an accelerometer, a gyroscope, a magnetometer, and a processor that extrapolate user actions from acceleration, rotation, and position data collected locally. In this example, Block S120 can also interface with an accelerometer, gyroscope, geographic coordinate (e.g., GPS) sensor, and a processor within the mobile computing device to detect a current user action or a change in a user action. Block S120 can also interface with one or more sensors, devices, and/or databases to retrieve local environmental information, general user or trend information (e.g., from various other users), etc. For example, Block S120 can communicate with a remote database via a computer network to retrieve weather information and historical user data pertaining to the user's current location.

In one example, Block S120 is implemented within a native application executing on the user's mobile computing device (e.g., a smartphone, a tablet, smart glasses with a heads-up display, a smart watch, etc.), and Block S120 interfaces with one or more wearable devices lined to the mobile computing device—such as a wristband fitness monitor wireless connected to the mobile computing device—to retrieve user motion (e.g., accelerometer and/or gyroscope), action, and/or activity data (e.g., “action identifiers”). Block S120 can similarly collect user motion from one or more sensors arranged within the mobile computing device and manipulate these motion data to locally determine a user action or activity and/or corroborate data received from the wearable device with motion, action, or activity data collected at the mobile computing device. In this example, Block S120 can generate a timeline (or “stream”) of user actions (or action changes by the user) based on user action data received from the wearable device and/or collected locally, and Block S120 can further calculate confidence scores for each action in the timeline, such as based on a comparison of actions determined from data collected at the wearable device and actions determined from data collected locally at the mobile computing device.

Block S120 can also interface with a standalone electronic device, such as a wireless-enabled bath scale to retrieve user weight. Block S120 can further interface with a database, a remote server, and/or a computer network, such as via an Internet connection, to retrieve user calendar information, rate and timing of textual communications (e.g., email), user hospital and/or health records, user access to a social networking system, local weather and environmental data, local food and/or grocery options, local trending or available activities, etc. In this implementation, Block S120 can further collect data through other sensors arranged within the mobile computing device. For example, Block S120 can collect the user's location and a location time stamp through a GPS sensor arranged within the mobile computing device, a rate and timing of the user's email, SMS text messaging, and phone communications through a related application executing on the mobile computing device, a user's schedule within a calendar application executing on the mobile computing device, and a rate and timing of the user's media consumption through a related application executing on the mobile computing device. However, Block S120 can collect various user and/or environmental data in any other suitable way, such as described in U.S. patent application Ser. No. 14/048,956.

### 5. Directive Selection

Block S130 of the method S100 recites generating a first directive for the user according to the first set of motion data and a first rule defined within the first wellness application. Block S130 can similarly recite selecting a first directive from the first habit program for presentation to the user according to the first set of motion data. Generally, Block S130 functions to implement one or more rules defined by a current wellness application in the user's wellness account to generate a timely reminder to perform a future action and/or to generate timely feedback in response to a recent user action, new user data, and/or new environment data.

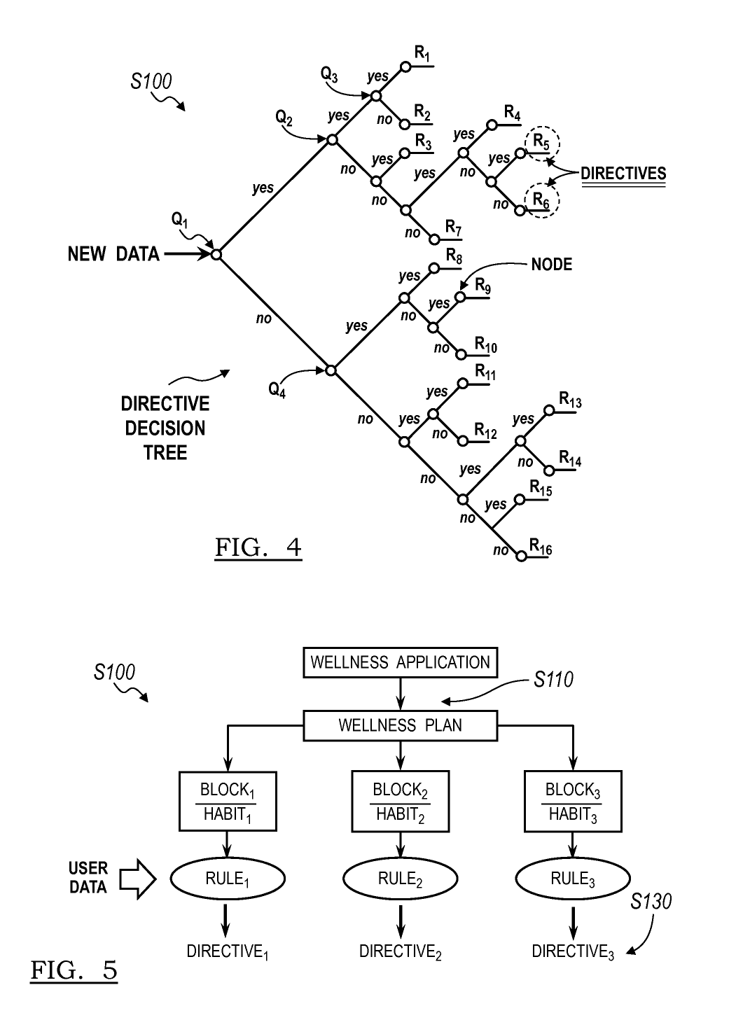

In one implementation, a wellness application includes a pre-populated list of directives, and Block S130 selects a directive from the pre-populated list based on user and/or environmental data recently collected in Block S120. In one example, as shown in FIG. 4, each wellness application defines a decision tree with a (complete) directive specified at each node in the decision tree, and Block S130 applies a stream of user action data (as described above) to the decision tree move through branches of the decision tree eventually reaching a node of the decision tree defining a directive particularly applicable to the user at a current or projected time. In a similar example, the wellness application defines a decision tree with a form directive at each node, and Block S130 move through branches of the decision tree according to user and/or environmental data, selects a particular node defining a particular directive, and then complete the form directive with relevant user and/or environmental data. In the foregoing examples, the wellness application can include one decision tree for all habit programs, one decision tree per habit program or behavior, or any other number of decision trees that Block S130 can manipulate to select of a directive for the user. The wellness application can also include one or more decision tree(s) defining reminder-based directives for the user to perform an action and one or more decision trees defining feedback-based directives to respond to an action by the user, and Block S130 can apply historical user data (e.g., user trends), user goals, and/or a user progress within the habit program to one decision tree to select a reminder-based directive and apply recent user data to another decision tree to select a feedback-based directive for the user.

In another example, a wellness application can define a decision graph with each node in the graph pointing to at least one other node in the graph, and Block S130 can move through branches of the decision graph to select directives for the user over time without reaching a “dead-end” or final node of directives within the wellness application. However, each wellness application and/or habit program can define any other number of complete and/or form directives for reminding the user to perform an action and/or for responding to a recent action by the user, and Block S130 can select reminder- and/or feedback-based directives for the current habit program in any other suitable way.

Generally, as shown in FIGS. 6-9, a reminder-based directive can function to prompt a habit-building action by the user and can be specific to a habit program currently engaged by the user. In one example, for a diet-related wellness application in which the user is currently engaged in a food preparation-related habit program, Block S130 can implement user location data to select a directive—defined in the habit program—to prompt the user to purchase a particular foodstuff when the user is within a threshold distance of a grocer. In another example, for an eighteen-week marathon training wellness application in which the user is currently engaged in a ‘week ten’ habit program, Block S130 can apply current and forecast weather data to a training schedule for week ten of the marathon program to select a directive to prompt the user to begin a scheduled run one hour earlier to avoid a forecast rainstorm. Block S130 can further insert local environmental data (collected in Block S110) into a form directive and set a delivery time for the directive based on the environmental data, such as by entering a weather forecast for a location proximal the user (i.e., proximal the user's computing device). Therefore, Block S130 can select or generate directives including content that is (immediately) applicable to realization of an action specified in a habit program by the user, and Block S130 can select or generate directives in response to and/or that accommodate the user's location, local environmental conditions, and/or upcoming user activities.

In other examples, Block S130 can select a reminder-based directive that includes any of the following: 1) “You're 300 calories short of your calories burned goal, walk to the Giants game instead of taking a cab . . . don't worry, you'll make it!” 2) “Hey, your average walk to work is 12 minutes. Why not try to beat your best time and do it in 11?” 3) “It's going to rain in one hour, so let's get that run in right now!” 4) “The weather has changed unexpectedly, and that run doesn't look like it's going to happen. Hit the local gym on 24th Street and do your intervals on the treadmill.” 5) “Hey, good morning. Here's your workout plan for the week. I'll ping you to remind you to get your gym clothes.” However, Block S130 can generate or select any other reminder-based directive including any other suitable content.

Generally, feedback-based directives can function to serve habit reinforcement, encouragement, and/or empathy to the user in response to a user action and/or inaction. Block S130 can select or generate feedback based on a habit program currently engaged by the user and/or based on new user data and/or new environmental data. As in the foregoing example in which the user is currently engaged in a food preparation habit-building habit program of a diet-related wellness application, Block S130 can determine that the user entered the grocer in response to the related reminder, prompt the user to confirm purchase of the particular foodstuff, and select feedback that includes a recipe for the foodstuff for the user as reward for completing the directive. Furthermore, as in the foregoing example in which the user is currently engaged in a daily ten-mile training habit program within a marathon training wellness application, Block S130 can analyze accelerometer data from a wristband to determine that the user is running and select feedback congratulating the user for completing the run before the forecast rain time. Therefore, Block S130 can select or generate feedback including content that is appropriately served to the user after a particular activity or inactivity.

Furthermore, in various examples, Block S130 can select a feedback-based directive that includes any of the following: 1) “Hey—great tennis you played there! It got you to your daily goal. Would you like us to remind you the same time next week to do a workout?” 2) “You had your best workout listening to these songs, this genre . . . do you want your music player to curate another playlist for tomorrow's workout?” 3) “This is your 3rd workout this week, and it was the most intense. Great job. Aim for another cardio workout in 2 days for optimal calorie burning.” 4) “You spend five hours of your workday completely sedentary. That's way above average. Taking a walking break now would break up the day and could get you to your daily step goal.” 5) “You burn the most calories on Thursdays, and the least on Wednesdays, so let's up your Wednesday count by doing a fifteen-minute walk now.” 6) “You're a workout pro. You worked out four times a week and burned 450 calories on average. You're rocking it!” 7) “You're 500 steps short of your daily steps goal, but grocery shopping is on your calendar and is a great way to get these last steps in before the end of the day.” 8) “Hey, you had a faster pace today! It might have been because of the outside temperature. Look how the past few day's temperature has impacted your performance.” However, Block S130 can generate or select any other feedback including any other suitable content. As shown in FIGS. 6 and 7, Block S130 can further select or generate a directive that includes a combination of a reminder and feedback for the user. Block S130 can also generate or select multiple directives substantially simultaneously, such as if the user has added multiple wellness applications to his wellness account.

Block S130 can therefore analyze raw sensor data to determine (e.g., estimate, predict) a user action. In one implementation, Block S130 translates accelerometer, gyroscope, and/or orientation (e.g., magnetometer) data collected by sensors within a wristband worn by the user and/or by sensors within a mobile computing device (e.g., smartphone) carried by the user into various user motions, actions, and/or activities tagged with start times, end times, and/or durations. In one example, Block S130 fuses data streams collected by sensors within one device worn or carried by the user and implements pattern recognition to classify these data stream into blocks of walking, biking, running, resting, working, driving, swimming, rowing, weightlifting, and/or sleeping, etc. In this example, for motion data recorded through sensors within a wrist-borne device, Block S130 can further manipulate these motion data to determine that the user is eating by characterizing repetitive motion between a plate position and a mouth position. Block S130 can further merge data streams or action classifications across multiple user-borne devices (e.g., a wearable device and a smartphone) to confirm action classifications and/or to calculate confidence scores for classified actions. Similarly, Block S130 can apply user location data, check-ins, calendar events, social networking system communications, user trends, etc. to confirm action classifications of these data streams, such as to confirm an “eating” classification by matching the user's GPS location with a restaurant or to confirm a “watching television” classification by comparing a current time of day and an historic daily schedule of the user to the “watching television” classification.

As described above, Block S130 can select or generate a directive in response to collection of new user data. In one implementation, the user's wellness account tracks and identifies trends in the user's actions (or activities) over time, and Block S130 responds to a recent detected action by the user that deviates from the user's action trends, as described in U.S. patent application Ser. No. 14/048,956. For example, the user's wellness account can identifying a common behavior (e.g., a “habit”) of the user from a set of previous motion data of the user collected from the computing device and the wearable device and generate an action calendar (or “map”) of predicted times at which the user with perform the behavior. In this example, Block S130 can then analyze new user data collected in Block S120, compare these data to the action calendar, and then select a directive (e.g., from a set of directives associated with the current wellness application) based on and in response to detected behavioral deviation by the user from the action calendar. Block S130 can also set a delivery time for the directive such that the directive is delivered to the user at a time substantially relevant to the user and to the deviation from the anticipated action. For example, if the user has selected a walking application to build a habit of walking more, the wellness account can determine that the user typically walks between 2 PM and 2:20 PM on weekdays, and Block S130 can select a directive to remind the user to walk or to ask the user why he did not walk if no walking action by the user is detected before 2:25 PM on a Tuesday. In this example, Block S130 can set a delivery time of ˜2:25 PM for the directive to the user such that the walking-related directive may be substantially relevant to the user in light of the user's action history.

Similarly, Block S130 can analyze the action calendar associated with the user and stored in the user's wellness account to predict an upcoming action to be performed by the user, select a directive for the user based on the predicted future action, and then set a delivery time of the first directive that precedes the time of the future action. For example, if the user has selected a walking application to build a habit of walking more, the wellness account can determine that the user typically walks between 2 PM and 2:20 PM on weekdays, and Block S130 can select a directive to remind the user to walk and can set a delivery time of ˜1:58 PM for the directive such that the walking-related directive reaches the user at a time that may be substantially relevant to the user.

The wellness account can also identify a trigger for a common user action, such as a time-related trigger, a location-related trigger, a weather-related trigger, or an activity-related trigger, etc. from historical user data, and Block S130 can select a directive related to a particular user action in response to detection of a trigger associated with the action and then set a delivery time for the directive based on the trigger. For example, if the user typically skips her evening walk on days during which she has lunch meetings, Block S130 can select a directive reciting, “You probably won't take your walk tonight, so how about walking back to the office after your last meeting today” in response to detection of the user in an office building other than her own between the hours of 12 PM and 1:30 PM on a weekday, and Block S130 can set a delivery time of 1:15 PM for the directive.

Block S130 can thus implement any of the foregoing techniques to select a directive for a current habit program in each wellness application within the user's wellness account. However, Block S130 can select any other type or number of directives in response to any other user and/or environmental data received in Block S120.

### 6. Conflict Resolution—Directives

Block S140 of the method S100 recites identifying a conflict between the first directive and a second directive, the second directive associated with a second wellness application selected by the user and electing the first directive for presentation to the user in place of the second directive according to a conflict resolution scheme. (Block S140 can similarly recite identifying a conflict between the first directive and a second directive, the second directive generated from motion data received from the wearable device according to a second rule defined within the second wellness application.) Generally, Block S140 functions to resolve a conflict between a first directive supported by a first wellness application and a second directive supported by a second wellness application. For example, Block S140 can implement a static conflict resolution scheme defined in the wellness platform, defined in a wellness application, or defined in a habit program to select and deselect conflicting directives for presentation to the user in Block S150. Alternatively, Block S140 can implement user preferences, response history of the user to directives, anticipated health value or effect of habit applications or current habit programs on the user, and/or estimated effort by the user to respond to a new or previous directive, etc. to rank wellness applications and/or a current habit programs within the user's wellness account—thereby generating a conflict resolution scheme—and filter directives generated in Block S130 accordingly. Block S140 can thus handle multiple directives output in Block S130 substantially simultaneously, such as in response to collection of new user data in Block S120. Block S140 can additionally or alternatively handle multiple directives output in Block S130 over time and queued for eventual deliver to the user. For example, Block S140 can filter a number of directives queued for delivery to the user over a period of time less than a threshold period of time suitable for delivery of the number of directives to the user, such as defined by the wellness platform.

In one implementation, as shown in FIG. 1, Block S130 can outputs a first directive for a first wellness application within the user's wellness account and a second directive for a second wellness application within the user's wellness account, such as in response to new user or environmental data. Block S140 can thus compare the first and second directives, identify a conflict between the directives, and retract (i.e., cancel, delete) or modify at least one of the directives accordingly.

In one example, the user's wellness account includes a diet program and a marathon training program, and Block S130 generates a first directive and a second directive, the first directive reciting “Be sure to eat a lot of green vegetables at dinner” according to the diet program, and the second directive reciting “It's time to carb-load! You have a big run in an hour” according to the marathon program. In this example, Block S140 identifies a contradiction between the first and second directives, prioritizes the fitness-related application (i.e., the marathon training program) over the diet-related application, and cancels the first directive due to the conflict with the prioritized fitness-related application. Furthermore, in this example, after the user consumes a carb-heavy meal and enters meal details into his wellness account (e.g., through his smartphone), Block S130 can generate a third directive and a fourth directive, the third directive reciting “it's okay, we all have cravings—next time, try to add a green vegetable to your meal” according to the diet program, and the fourth directive reciting “good job—now you're ready for your run!” according to the marathon program. Block S140 can then identify an inherent contradiction between the third directive and the fourth directive and delete the third directive before presentation to the user according to prioritization of the marathon training program over the diet program. Block S140 can thus detect and handle a contradiction between a first action specified in a directive for a first wellness application and a second action specified in a directive for a second wellness application.

In another example, the user's wellness account can include a sleep program and a stress training program. In this example, Block S120 can determine that the user just arrived home at 10:15 pm after a long and stressful day (e.g., based on a large influx of emails), and Block S130 can generate a first directive including “don't turn on the TV or pick up your tablet—just take a deep breath and go to bed” according to the sleep program and a second directive including “it's been a long day and your stress level is high—get in fifteen minutes of yoga to calm yourself and recover before bed” according to the stress program. In this example, Block S140 can identify a conflict between the directives but then combine the first and second directives into “it's been a long day and your stress level is high, so don't turn the TV on or pick up your tablet—just do fifteen minutes of yoga to calm yourself and then go to bed,” thereby resolving the conflict.

Block S140 can also filter two or more (i.e., a set of) directives generated or selected in Block S130, such as based on a maximum number of directives allowed for delivery to the user within a period of time. For example, Block S140 can select a first directive, from a set of directives, that is particularly pertinent to a prioritized user goal (e.g., running a marathon, losing 5 lbs.) and pass the particular directive to Block S150 to present to the user. In this example, Block S140 can withhold a second directive in the set of directives for a later time when the second directive is more relevant (e.g., timely) and/or does not conflict with a prioritized user goal driving the first directive. Alternatively, Block S140 can determine that the second directive will not achieve a threshold relevance to the user by the later time and thus delete the second directive. Therefore, Block S140 can select a particular directive, from a set of directives output in Block S130, to present to the user in Block S150.

Block S140 can similarly handle two or more feedback-related directives output (e.g., substantially simultaneously) in Block S130, such as in response to new user or environmental data. In various examples, Block S140 can select a particular feedback-related directive, from a set of feedback-related directives, that addresses a wellness area in which the user is struggling most, that is most relevant to the user at the current time (e.g., in response to a substantially unique or uncommon event), or that addresses a prioritized user goal (e.g., a short-term goal or a long-term goal) and then cancel or delay delivery of remaining directives in the set. In another example, Block S140 can select a feedback-related directive that addresses a significant recent effort by the user to achieve a goal, such as by selecting a positive comment from a marathon application in response to the user's completion of a twelve-mile run rather than feedback from a diet application suggesting that the user change add more vegetables to his diet. In particular, Block S140 can cooperate with Block S130 to estimate a level of physical and/or emotional effort that the user exerted to perform a particular action or to develop a particular behavior and elect a particular directive to present to the user in Block S150 accordingly.

Similarly, Block S140 can filter a set of directives output in Block S130 based on a predicted response to each directive by the user. For example, Block S140 can calculate a first confidence in a positive response by the user to a first directive based on a history of the user in responding to similar directives, calculate a second confidence in a positive response by the user to a second directive based on a history of the user in responding to similar directives, elect the first directive in place of the second directive if the first confidence exceeds the second confidence, and vice versa.

Block S140 can therefore prioritize, modify, remove, and/or adjust the timing of various directives generated in Block S130 and presented to the user in Block 150 in response to conflicts between the various directives. Block S140 can also apply input data collected in Block S120 to select a particular directive to pass to Block S150, such as user location data, manually-entered data (e.g., textual entry of “I just ate two huge white potatoes with cheese and sour crème” by the user into his smartphone), weather data, a current user action determined from motion data as described above, etc.

Block S140 can also predict a user variable and implement the predicted user variable to resolve a conflict between directives. For example, Block S140 can analyze the user's daily email influx and correlate the number of emails received by the user (or an email influx greater than a daily average) with a user stress level and thus select a directive to pass to Block S150 based on the user's perceived current stress level, such as by selecting a directive that recites “taking a deep breath and take two minutes to stretch as your desk” rather than a directive that recites “get psyched for you 15-mile run tonight!” Block S140 can also predict a future or upcoming user action based on the user's habits, trends, calendar events, and/or user history in fulfilling saved calendar events. Block S140 can thus apply any of this data to resolve conflicts between directives and/or feedback output in Block S130.

### 7. Conflict Resolution—Habit Program

As shown in FIG. 10, in one variation of the method S100, Block S140 recites identifying a conflict between the first habit program and a second habit program within the second wellness application based on a conflict resolution scheme. Generally, in this variation, Block S140 functions to resolve conflicts between two habit programs within two corresponding habit applications by electing one of the habit programs to enable and another habit program to sufficiently delay or cancel entirely on behalf of the user. In particular, Block S140 can implement the conflict resolution scheme to detect two habit programs currently elected and/or soon to be engaged in the user's wellness account but that define substantially similar behaviors for development, are likely to yield conflicting directives, that may be potential harmful to the user if pursued in parallel (i.e., substantially simultaneously), or that may be potential harmful to the user if pursued serially but within less than a safety period of time between habit programs. For example, the user can be currently engaged in a first habit program in a first wellness application and a second habit program in a second wellness application simultaneously, and Block S112 can detect completion of the second habit program in the second wellness application, as described above, and then select a new third habit program from the second wellness application for the user. However, selection of the habit program can trigger Block S140 to check the third habit program for conflicts with the first habit program. Thus, if Block S140 identifies a conflict, Block S140 can trigger Block S112 to select a different habit program in the second wellness application. Block S140 can thus implement methods and techniques similar to those described above to detect a conflict between habit programs across two distinct wellness applications elected to one wellness account.

In one implementation, Block S140 identifies a potential health hazard in simultaneous development of a first behavior targeted in the first habit program and a second behavior targeted in the second habit program. In one example, example, a marathon training application is currently loaded into the user's wellness account, and a “taper week” training program is currently engaged within the marathon training application as the user moves through the last week of training before race day. In this example, the user has recently selected a diet application with a default habit program specifying a highly restricted diet to guide identification of particular food allergies such that a diet program can be tailored to the user's food allergies and such that subsequent habit programs within the diet application can accommodate this custom diet program. However, Block S140 detects a potential health-related conflict between a restricted diet for allergy identification and caloric need for the upcoming marathon, prioritizes the marathon training application over the diet application (e.g., due to the amount of effort made by the user to train over eighteen weeks for the marathon), and thus pauses the default habit program within the diet application while maintain the taper week training program in the marathon training application until after race day.

In another implementation, Block S140 can detect a similarity greater than a threshold similarity between a first behavior specified for development in the first habit program and a second behavior specified for development in the second habit program and selectively engage and disengage habit programs based on such similarity (such as prompted by the conflict resolution scheme). In one example, a walking application is currently loaded onto the user's wellness account with a (first) habit program specifying development of weekday afternoon walking behavior currently engaged. However, following a car accident that reduces his mobility, the user elects a physical therapy application to guide the user in improving his mobility through walks of increasing duration over time, and a (second) habit program within the physical therapy application and currently engaged in the user's wellness account can specify development of a daily walking routine of a particular duration (e.g., 13:00 minutes) for the current week. In this example, Block S140 can detect a similarity between the first habit program and the second habit program and pause or cancel either of the habit programs according to the conflict resolution scheme, such as by cancelling the first habit program in favor of the second habit program within the physical therapy application because the physical therapy application may be more accommodating to the user's current condition than the more generic walking application. (Block S140 can also switch back to the first habit program in the walking application once the physical therapy application is completed and/or is removed from the user's wellness account). As described below, Block S140 can also cooperate with Block S112 to select an alternative (third) habit program from the walking application—such as a water consumption program that prompts the user to drink at least eight glasses of water each day—while the user is engaged in the second habit program within the physical therapy application. Block S140 can therefore cooperate with Block S112 to deselect one habit program and to select an alternative habit program specifying an alternative behavior for development in response to a similarity between current habit programs that exceeds a threshold similarity (such as defined within the conflict resolution scheme).

Block S140 can also rank an importance of a first wellness application over an importance of a second wellness application and identify conflicts between habit programs in the wellness applications according to such rank and the conflict resolution scheme. In one example, the user's wellness account includes a stress management program and an intermittent sleep program. In this example, the intermittent sleep program can define a rigorous intermittent sleep schedule with rigid sleep times that are not to be missed by more than two minutes, and the user can be currently engaged in a habit program within the intermittent sleep program to build awareness of sleep time rigidity. Furthermore, the stress management program can include a habit program defining a morning post-waking yoga routine. However, in this example, because user adherence to the sleep program may have a significantly greater impact on short-term user wellness, Block S140 can prioritize the sleep program habit program over the morning yoga habit program. Block S140 can also remove the morning yoga habit program from the user's current routine once the sleep program is engaged in the user's wellness account due to the number of waking periods the user may experience in a single day under an intermittent sleep schedule. Block S140 can additionally or alternatively limit a number of morning yoga-related directives passed to Block S150, such as by passing a yoga-related directive to Block S150 only when the morning yoga-related directives do not conflict with the sleep program. Block S140 can therefore prioritize a habit program of one wellness application over a habit program of another wellness application.

In this variation, Block S140 can also cooperate with Block S112 to select a most appropriate habit program—from a set of habits programs specified across multiple wellness applications—for the user to engage over particular periods of time, thereby prioritizing a particular habit program over other habit programs available in the user's wellness account. Block S140 can also interface with Block S112 to select a particular habit program—from a set of habit programs defining within a particular wellness application—to serve to the user, such as a goal to workout for five minutes every other day or a goal to complete a fifteen-minute workout everyday, as defined in a fitness-related habit program in a wellness application. For example, Block S140 (and Block S112) can order habits specified in one or more wellness applications such that the user engages in successively more difficult habit program and/or habit programs that build on previous habit programs (e.g., by building on user behaviors developed in previous habit programs). Block S140 can also reorder habit programs in a wellness application to reduce potential or predicted conflict with a habit program in another wellness application. For example, Block S140 can order habit programs in a diet program to complement rather than conflict with habit programs in a fitness program such that the diet program supports the user is consuming sufficient calories and nutrients for the fitness of the user specified throughout habit programs of the fitness application. Block S140 can thus cooperate with Block S112 to enable the user to engage in habit programs from multiple wellness applications simultaneously by reducing conflicts between habit programs across the multiple wellness applications.

Thus, in this variation, Block S140 can trigger Block S120 and Block S130 to repeat to generate a second directive—based on the alternative habit program selected in cooperation with Block S112—for the user. For example, once Block S140 detects a conflict between a first habit program in a first wellness application and a second habit program in a second wellness applications, cancels the second habit program, and elects a third habit program from the second wellness application in cooperation with Block S110, Block S120 can receive a second set of motion data collected by the wearable device wirelessly (i.e., at a second, later time), and Block S130 can then select a second directive from the third habit program for presentation to the user according to the second set of motion data. Therefore, Blocks of the method S100 (e.g., Blocks S120 and S130) can repeat over time to generate new directives across various habit programs within various wellness applications as additional user (and/or environmental) data is collected through the user's wearable device and/or mobile computing device.

### 8. Conflict Resolution—Wellness Application

As shown in FIG. 11, in another variation of the method S100, Block S140 recites identifying a conflict between the first wellness application and the second wellness application and rejecting the second wellness application from the wellness account based on the conflict in Block S140. In this variation, Block S140 can thus functions to resolve conflicts at the wellness application level, thereby preventing election of a second wellness application—to a user's wellness account—that conflicts with a first wellness application already loaded into the user's wellness account.

In one implementation, Block S140 identifies a contradiction between a first target behavior targeted within the first wellness application and a second target behavior targeted within the second wellness application, the first target behavior and the second target behavior corresponding to a particular wellness category. For example, a user has previously selected and is currently engaged in a marathon training application, Block S110 receives a user election for a low-carb diet application, and Block S140 can implement the conflict resolution scheme to determine that a low-carb diet may obstruct the user's ability to achieve marathon-related goals. In this example, the marathon training application can include a conflict resolution scheme that defines a minimum carbohydrate intake algorithm and a nutrient requirement algorithm based on training week and user age, gender, and weight. Block S140 can thus calculate a minimum carbohydrate and nutrient requirement for the training week of the current habit program in the marathon training application based on the known age, gender, and weight of the user, compare these calculated carbohydrate and nutrient requirements to target carbohydrate and nutrient amount specified in a default habit program within the low-carb diet application, and detect a conflict between the estimated requirements to achieve behaviors defined in the marathon training application and a behavior specified in the low-carb diet application. Block S140 can thus cancel or restrict election of the low-carb diet application accordingly.

Block S140 can also identify a potential health hazard in simultaneous execution of the first wellness application and the second wellness application by the user and reject election of the latter (i.e., second) wellness application accordingly. As in the previous example, Block S140 can determine that a discrepancy between a minimum carbohydrate and nutrient consumption requirement defined by the marathon training application and a maximum carbohydrate allotment defined by the low-carb diet application may reach an unhealthy level, and Block S140 can thus reject election of the low-carb diet application. Similarly, Block S140 can identify a potential health hazard in execution of the second wellness application within a threshold time of completion of the first wellness application by the user and rejects election of the second wellness application accordingly. For example, if the user completed the marathon training application one week prior and was consuming ˜6,000 calories in carbohydrates alone per day at completion of the marathon training application, Block S140 can determine that transitioning from a high-carb diet specified in the marathon training application to a low-carb diet program specified in the low-carb diet application within one week falls outside of an allowable (or threshold) transition period between behaviors within the same wellness category (i.e., a diet-related wellness category), such as defined in the conflict resolution schema. In this example, Block S140 can thus prevent election of the low-carb diet program until the allowable transition period (specific to the diet-related wellness category) is reached.

In one implementation, Block S140 can compare wellness applications currently loaded into the user's wellness account against all other available wellness application supported by the wellness platform, detect available wellness applications that conflict with the user's current wellness application, and then filter out conflicting wellness applications from a wellness application store (e.g., accessible through the native application executing on the user's mobile computing device) through which the user selects of purchases new wellness applications such that the user does not see conflicting wellness applications when searching the wellness application store for new wellness applications to load into his wellness account. In another example, Block S140 analyzes available wellness applications for conflicts when the accesses the wellness application store, and Block S140 then flags or ‘greys out’ new wellness applications—that conflict with the user's current or recent wellness applications—within the wellness application store as the user thumbs through the store. Block S140 can thus preemptively filter out wellness applications that conflict with current or recent wellness applications elected by the user. Alternatively, Block S140 can detect conflicts between current and new wellness applications in response to election of a new wellness application. For example, Block S110 can receive a selection for a new wellness application, and Block S140 can compare the new wellness application to a wellness application currently or recently loaded onto the user's wellness account, detect a conflict between the current and new wellness applications, and throw a flag to reject the new wellness application accordingly. Block S140 can thus maintain a first current wellness application within the user's wellness account and reject a second new wellness application from the user's wellness account substantially in real-time when the second wellness application is selected by the user.

However, Block S140 can function in any other way to detect and resolve a conflict between two wellness applications, two habit programs or habits, and/or two directives, etc.

### 9. Directive Presentation

As shown in FIGS. 6, 7, 8, and 9, Block S150 of the method S100 recites presenting the first directive to the user in place of the second directive according to a conflict resolution scheme. Generally, Block S150 functions to receive one or more directives from Block S130 and to present the directive(s) to the user, such as through a user interface within a native application executing on a mobile computing or wearable device, through a dashboard accessible through a web browser on a computing device, or in the form of a notification on a locked screen or a home screen of the mobile computing device.

Block S150 can support multiple communication channels, such as in the form of one chat-style textual communication channel for each wellness application (shown in FIG. 8), wherein Block S150 publishes (e.g., pushes) a directive for a particular wellness application into a communication channel corresponding to the particular wellness application. Block S150 can additionally or alternatively communicate directives to the user as pop-up messages notifications, emails, SMS text messages, messages within a native application executing on the user's mobile computing device (as shown in FIG. 9), or any other suitable type of textual communication, such as through a mobile computing device, a wearable device, etc.

Block S150 can also communicate visual or audible directives to the user, such as in the form of video, music, calendar updates, progress screens, or other media to the user.

In one implementation, Block S150 interfaces with an intelligent personal assistant (i.e., a mobile software agent) executing on a smartphone (or other mobile computing device) to communicate directives to the user through a voice emulator. For example, Block S150 can emulate a live coach and enable two-way communication between the user and the user's wellness account through the intelligent personal assistant. In particular, in this example, Block S150 can interface with the intelligent personal assistant to enable the user to interact in a back-and-forth conversation with the system to give and receive details and directives pertaining to a wellness application, user- and/or program-specified goals, habits and/or habit programs, user actions, needs, or interests, user questions, empathy, etc.

In this implementation, Block S110 can also interface with the intelligent personal assistant to receive a user selection for a wellness application and Block S120 can interface with the intelligent personal assistant to collect user and/or environmental data. For example, Block S120 can present a question to the user and retrieve a response from the user through the intelligent personal assistant, such as through a voice recognition applet within the intelligent personal assistant. In this example, Block S130 can then implement the user's response to generate or select a relevant directive for the user, and Block S150 can output the directive to the user in a spoken language format. Therefore, Block S150 (and/or other Blocks of the method S100) can interface with an intelligent personal assistant executing on or accessible through the user's mobile computing device, wearable device, or other electronic device (e.g., through a web browser on a desktop computer) to communicate directives to the user and/or to receive data from the user.

Block S150 can additionally or alternatively present a form of the directive to the user through a wearable device worn by the user. For example, Block S150 can transmit a command to ‘buzz’ a wireless-enabled wristband worn by the user to indicate to the user that a new directive awaits, and Block S150 can subsequently display the directive on the user's smartphone, such as in the form of a notification displayed over a locked home screen on the smartphone.

The systems and methods of the preferred embodiment can be embodied and/or implemented at least in part as a machine configured to receive a computer-readable medium storing computer-readable instructions. The instructions are preferably executed by computer-executable components preferably integrated with the application, applet, host, server, network, website, communication service, communication interface, hardware/firmware/software elements of a user computer or mobile device, wristband, smartphone, or any suitable combination thereof. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention as defined in the following claims.

We claim:

1. A method for providing wellness-related directives to a user, comprising:
at a computing device associated with the user, receiving a selection for a first wellness application and a selection for a second wellness application;
receiving a first set of motion data collected by the computing device and a wearable device wirelessly coupled to the mobile computing device;
generating a first directive for the user according to the first set of motion data and a first rule defined within the first wellness application;
identifying a conflict between the first directive and a second directive, the second directive generated from motion data received from the wearable device according to a second rule defined within the second wellness application; and
electing the first directive for presentation to the user in place of the second directive according to a conflict resolution scheme.

2. The method of claim 1, wherein receiving the selection for the first wellness application comprises receiving an election for loading a diet-related application into a wellness account associated with the user, and wherein receiving the selection for the second wellness application comprises receiving an election for loading a fitness-related application into the wellness account, the diet-related application supported by a first third-party provider, the fitness-related application supported by a second third-party provider other than the first third-party provider, and the first third-party provider and the second third-party provider external the wellness account.

3. The method of claim 1, further comprising identifying a behavior of the user from a set of previous motion data of the user collected from the computing device and the wearable device, wherein generating the first directive comprises detecting a behavioral deviation of the user based on a comparison of the behavior of the user and the first set of motion data and selecting the first directive from a set of directives associated with the first wellness application based on the behavioral deviation.

4. The method of claim 1, further comprising identifying a previous action of the user from data collected through the computing device during a previous period of time, and wherein generating the first directive comprises predicting a future action of the user and a time of the future action based on the previous action, selecting the first directive from a set of directives associated with the first wellness application based on the predicted future action, and setting a delivery time of the first directive that precedes the time of the future action.

5. The method of claim 1, wherein identifying the conflict between the first directive and the second directive comprises detecting a contradiction between a first action specified in the first directive and a second action specified in the second directive, and wherein electing the first directive in place of the second directive comprises ranking an importance of a first current habit program of the first wellness application over an importance of a second current habit program of the second wellness application according to the conflict resolution scheme.

6. The method of claim 5, wherein generating the first directive comprising retrieving local environmental data from a remote database, inserting local environmental data into the first directive, and setting a delivery time for the first directive to the user based on a weather forecast for a location proximal the computing device.

7. The method of claim 1, wherein identifying the conflict between the first directive and the second directive comprises identifying a set delivery time of the second directive within a threshold time of a set delivery time of the first directive, and wherein electing the first directive in place of the second directive comprises calculating a first confidence in a positive response to the first directive based on a history of the user and the conflict resolution scheme, calculating a second confidence in a positive response to the second directive based on the history of the user and the conflict resolution scheme, and electing the first directive in place of the second directive according to the first confidence exceeding the second confidence.

8. A method for providing wellness-related directives to a user, comprising:
at a computing device associated with the user, receiving a selection for a first wellness application and a selection for a second wellness application;
selecting a first habit program within the first wellness application;
receiving a first set of motion data collected by the computing device and a wearable device wirelessly coupled to the mobile computing device;
selecting a first directive from the first habit program for presentation to the user according to the first set of motion data;
identifying a conflict between the first habit program and a second habit program within the second wellness application based on a conflict resolution scheme;
selecting a third habit program within the second wellness application in place of the second habit program;
receiving a second set of motion data collected by the wearable device wirelessly; and
selecting a second directive from the third habit program for presentation to the user according to the second set of motion data.

9. The method of claim 8, wherein selecting the first habit program within the first wellness application comprises correlating actions by the user within a previous period of time with establishment of a behavior targeted in a previous habit program within the first wellness application, terminating the previous habit program in response to establishment of the behavior targeted in the previous habit program, and selecting the first habit program within the first wellness application in response to termination of the previous habit program.

10. The method of claim 9, wherein selecting the first habit program within the first wellness application comprises selecting the first habit program from a set of habit programs defined within the wellness application according to a selected goal of the user, a behavior targeted in the previous habit program, and a perceived difficulty of the previous habit program.

11. The method of claim 9, wherein receiving the selection for the first wellness application and the selection for the second wellness application comprises receiving the selection for the first wellness application at a first time, receiving the selection for the second wellness application at a second time succeeding the first time, and selecting the second habit program defining a default initial habit program within the second wellness application in response to receiving the selection for the second wellness application.

12. The method of claim 11, wherein identifying the conflict between the first habit program and the second habit program comprises detecting a similarity greater than a threshold similarity between a first behavior specified for development in the first habit program and a second behavior specified for development in the second habit program, the threshold similarity defined in the conflict resolution scheme, and wherein selecting the third habit program within the second wellness application comprises deselecting the second habit program and selecting the third habit program specifying a third behavior for development in response to the similarity greater than the threshold similarity.

13. The method of claim 8, wherein receiving the selection for the first wellness application and the selection for the second wellness application comprises receiving an election for loading the first wellness application into a wellness account associated with the user at a first time and receiving an election for loading the second wellness application into the wellness account at a second time succeeding the first time, and wherein identifying the conflict between the first habit program and the second habit program comprises identifying a potential health hazard in simultaneous development of a first behavior targeted in the first habit program and a second behavior targeted in the second habit program.

14. The method of claim 13, wherein identifying the conflict between the first habit program and the second habit program comprises ranking an importance of the first wellness application over an importance of the second wellness application according to the conflict resolution scheme, and wherein selecting the third habit program comprises selecting the third habit program within the second wellness application in response to a ranked importance of the first wellness application over a ranked importance of the second wellness application.

15. The method of claim 8, wherein receiving the first set of motion data comprises collecting a first set of action identifiers from the computing device and collecting a second set of action identifiers from the wearable device, and wherein selecting the first directive comprises identifying a trigger for a behavior of the user from the first set of action identifiers and the second set of action identifiers, selecting the first directive associated with the behavior, and setting a delivery time for the first directive based on the trigger.

16. The method of claim 8, further comprising displaying the first directive on the computing device at a first time and displaying the second directive on the computing device at a second time succeeding the first time.

17. A method for providing wellness-related directives to a user, comprising:
receiving, from a user, an election of a first wellness application to a wellness account associated with the user;
receiving a set of motion data collected by a computing device and a wearable device, the computing device linked to the wellness account, the wearable device in wirelessly communication with the mobile computing device;
identifying completion of a first habit program by the user based on the set of motion data, the first habit program defined within the first wellness application;
selecting a second habit program within the first wellness application in response to completion of the first habit program by the user;
receiving, from the user, an election of a second wellness application to the wellness account;
identifying a conflict between the first wellness application and the second wellness application; and
rejecting the second wellness application from the wellness account based on the conflict.

18. The method of claim 17, wherein identifying the conflict between the first wellness application and the second wellness application comprises identifying a potential health hazard in simultaneous execution of the first wellness application and the second wellness application by the user.

19. The method of claim 17, wherein identifying the conflict between the first wellness application and the second wellness application comprises identifying the potential health hazard in execution of the second wellness application within a threshold time of completion of the first wellness application by the user.

20. The method of claim 17, wherein receiving the election of the first wellness application to the wellness account comprises receiving the election of the first wellness application corresponding at a first time, wherein receiving the election of the second wellness application to the wellness account comprises receiving the election of the second wellness application at a second time succeeding the first time, wherein identifying the conflict between the first wellness application and the second wellness application comprises identifying a contradiction between a first target behavior targeted within the first wellness application and a second target behavior targeted within the second wellness application, the first target behavior and the second target behavior corresponding to a particular wellness category, and wherein rejecting the second wellness application from the wellness account comprises maintaining the first wellness application within the wellness account and rejecting the second wellness application from the wellness account substantially at the second time.

21. The method of claim 17, wherein identifying completion of the first habit program by the user comprises identifying a series of actions by the user over a period of time from the set of motion data, correlating the series of actions by the user with establishment of a first behavior targeted in a first habit program within the first wellness application, and terminating the first habit program in response to establishment of the first behavior targeted in the first habit program, wherein selecting the second habit program within the first wellness application comprises selecting the second habit program targeting a second behavior building on the first behavior in response to termination of the first habit program.

22. The method of claim 17, further comprising selecting a directive from a set of directives associated with the first habit program based on the set of motion data and displaying the directive as a notification on the computing device.
